(19) United States
(12) Patent Application Publication
(10) Pub. No.: US 2025/0242247 A1
(43) Pub. Date: Jul. 31, 2025

(54) LEVEL COMPLETION INTERFACE DISPLAY METHOD AND APPARATUS, TERMINAL, AND STORAGE MEDIUM

(71) Applicant: Tencent Technology (Shenzhen) Company Limited, Shenzhen (CN)

(72) Inventors: Lu Wang, Shenzhen (CN); Huayu Tong, Shenzhen (CN)

(21) Appl. No.: 19/059,421

(22) Filed: Feb. 21, 2025

Related U.S. Application Data
(63) Continuation of application No. PCT/CN2024/071050, filed on Jan. 8, 2024.

(30) Foreign Application Priority Data
Mar. 7, 2023 (CN) 202310245171.X

(51) Int. Cl. A63F 13/537

(52) U.S. Cl. CPC A63F 13/537

(57) ABSTRACT

A level completion interface display method and apparatus, a terminal, and a storage medium, belonging to the technical field of human-machine interaction. The method includes: displaying a task completion condition of a current level and a task progress bar in a level completion interface, where the task progress bar includes an i^{th} stage goal and an i^{th} goal achievement reward corresponding to the i^{th} stage goal; displaying a second progress value; and displaying, in a case that the second progress value reaches the i^{th} stage goal, an (i+1)^{th} stage goal and an (i+1)^{th} goal achievement reward corresponding to the (i+1)^{th} stage goal in the task progress bar.

### CROSS REFERENCE TO RELATED APPLICATIONS

This application is a continuation application of PCT Application PCT/CN2024/071050, filed Jan. 8, 2024, which claims priority to Chinese Patent Application No. 202310245171.X, filed on Mar. 7, 2023, each entitled “LEVEL COMPLETION INTERFACE DISPLAY METHOD AND APPARATUS, TERMINAL, AND STORAGE MEDIUM”, and each which is incorporated herein by reference in its entirety.

### FIELD

Aspects described herein relate to the field of human-machine interaction technologies, and in particular, to a level completion interface display method and apparatus, a terminal, and a storage medium.

### BACKGROUND

Level completion refers to a process of scoring and rewarding settlement of behaviors of a player in a level after the player passes the level.

In a related technology, after a player completes a level, a completion condition of a current level and a reward obtained by passing the level are presented on a level completion interface, and the reward is related to the completion condition. For example, the level completion interface displays a star level (which is determined based on factors such as a level passing time and a score) and virtual experience, virtual gold coins, and the like obtained.

A plurality of game goals are set in some games, and the game goals are related to the number of completed tasks. Whether a game goal is reached and the number of reached game goals may be determined by comprehensively considering the number of completed tasks in a plurality of levels, to improve long-term activeness of a player in a game. However, the foregoing level completion interface can only provide a completion condition of a current level. If the player wants to view a completion condition of another game goal, the player needs to exit the level completion interface, and view in a dedicated goal presentation interface. Consequently, viewing efficiency is relatively low.

### SUMMARY

Aspects described herein provide a level completion interface display method and apparatus, a terminal, and a storage medium, to enrich display content of a level completion interface, thereby improving efficiency of viewing a goal completion condition by a player. Technical solutions are as follows:

In one aspect, a level completion interface display method is executed by a computer device, the method including:
displaying a task completion condition of a current level and a task progress bar in a level completion interface, the task progress bar including an i^{th} stage goal and an i^{th} goal achievement reward corresponding to the i^{th} stage goal, and the task progress bar corresponding to a first progress value;
displaying a second progress value, the second progress value being a progress value obtained by updating the first progress value based on the task completion condition; and
displaying, in a case that the second progress value reaches the i^{th} stage goal, an (i+1)^{th} stage goal and an (i+1)^{th} goal achievement reward corresponding to the (i+1)^{th} stage goal in the task progress bar.

In another aspect, a level completion interface display apparatus may include:
a display module, configured to display a task completion condition of a current level and a task progress bar in a level completion interface, the task progress bar including an i^{th} stage goal and an i^{th} goal achievement reward corresponding to the i^{th} stage goal, and the task progress bar corresponding to a first progress value; and
an update module, configured to display a second progress value, the second progress value being a progress value obtained by updating the first progress value based on the task completion condition; and
the display module being further configured to display, in a case that the second progress value reaches the i^{th} stage goal, an (i+1)^{th} stage goal and an (i+1)^{th} goal achievement reward corresponding to the (i+1)^{th} stage goal in the task progress bar.

In another aspect, a terminal may include a processor and a memory; the memory having at least one instruction stored therein, the at least one instruction, when executed by the processor, implementing the level completion interface display method described above.

In another aspect, a computer-readable storage medium may have at least one instruction stored therein, the at least one instruction, when executed by a processor, implementing the level completion interface display method described above.

In another aspect, a computer program product, including computer instructions, may be provided, the computer instructions being stored in a computer-readable storage medium. A processor of a computer device reads the computer instructions from the computer readable storage medium, and the processor executes the computer instructions, causing the computer device executes the level completion interface display method described above.

In the aspects described herein, in addition to displaying the task completion condition of the current level, the task progress bar is further displayed on the level completion interface, and the task progress bar is configured to enable the user to view goals in a current stage and corresponding goal achievement rewards. In addition, the first progress value corresponding to the task progress bar supports dynamic update according to the task completion condition to obtain the second progress value. After the second progress value reaches a current-stage goal, the task progress bar can display a next-stage goal and a corresponding goal achievement reward, so that the user can quickly learn stage goal information of the current stage and a next stage through the level completion interface, and interface switching does not need to be performed between the level completion interface and a stage goal display interface, thereby improving information viewing efficiency. In addition, the level completion interface focuses display of the stage goals at the current stage and the next stage, so as to avoid interference caused to the user to obtain effective information due to display of excessive stage goals.

### BRIEF DESCRIPTION OF THE DRAWINGS

FIG. 1 is a schematic interface diagram of a stage goal completion condition view process in related art.

FIG. 2 shows a flowchart of a level completion interface display method in accordance with one or more illustrative aspects described herein.

FIG. 3 is a schematic interface diagram of a level completion interface display process shown in accordance with one or more illustrative aspects described herein.

FIG. 4 shows a flowchart of a level completion interface display method in accordance with one or more illustrative aspects described herein.

FIG. 5 is a schematic interface diagram of a level completion interface display process in accordance with one or more illustrative aspects described herein.

FIG. 6 is a schematic diagram of an interaction process of a UI layer and a logic layer in accordance with one or more illustrative aspects described herein.

FIG. 7 is a schematic diagram of a task progress bar in a task completion status in accordance with one or more illustrative aspects described herein.

FIG. 8 is a schematic interface diagram of a level completion interface display process in accordance with one or more illustrative aspects described herein.

FIG. 9 is a schematic interface diagram of a level completion interface display process in accordance with one or more illustrative aspects described herein.

FIG. 10 is a schematic implementation diagram of a task progress bar dragging process in accordance with one or more illustrative aspects described herein.

FIG. 11 is a schematic interface diagram of a highlighting process of a repeated challenge control in accordance with one or more illustrative aspects described herein.

FIG. 12 is a schematic interface diagram of a default display process of a repeated challenge control in accordance with one or more illustrative aspects described herein.

FIG. 13 is a schematic interface diagram of a highlighting process of a repeated challenge control in accordance with one or more illustrative aspects described herein.

FIG. 14 shows a structural block diagram of a level completion interface display apparatus in accordance with one or more illustrative aspects described herein.

FIG. 15 is a schematic structural diagram of a terminal in accordance with one or more illustrative aspects described herein.

### DETAILED DESCRIPTION

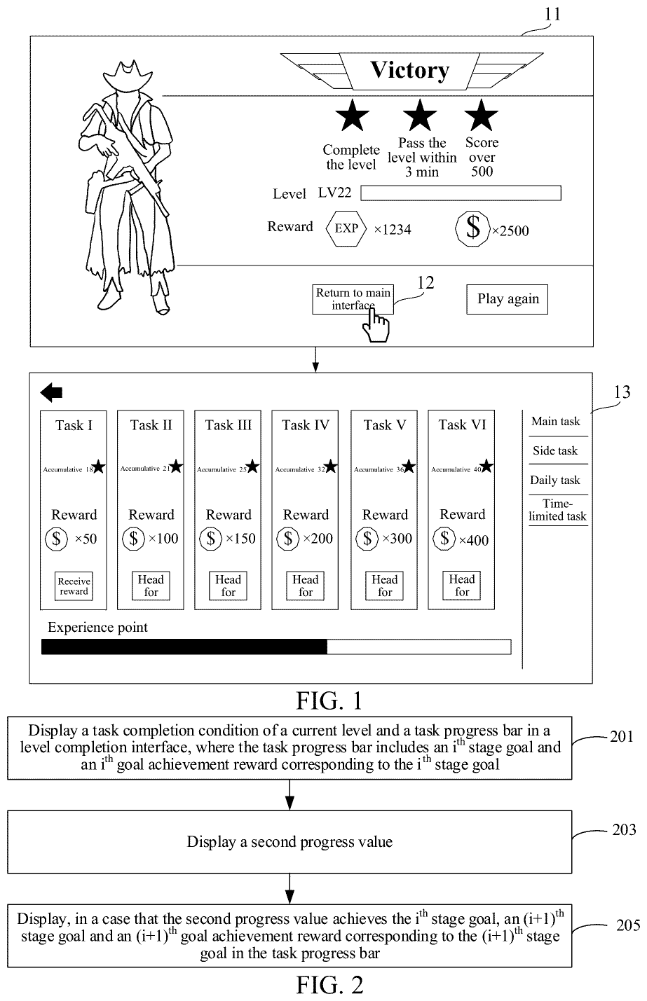

As shown in FIG. 1, in the related art, a completion condition of a current level and a reward obtained by passing the current level are displayed on a level completion interface 11. An example in which stage goals and corresponding goal achievement rewards are set in an application is used. For example, when different stage goals correspond to different quantities of accumulated stars (obtained by passing a level), when a user wants to view completion progresses of the stage goals, the user first needs to trigger a return control 12 in the level completion interface 11 to return to a main interface of the application, and then triggers a task list control in the main interface of the application, so as to view the stage goals and corresponding goal completion conditions in a task display interface 13.

When viewing the stage goal completion progress by using the foregoing solution, different interfaces need to be switched, resulting in low efficiency of querying the completion progress. In addition, all stage goals may be displayed in the task display interface, and the process may affect an objective of obtaining effective information by the user because excessive information is displayed.

In the level completion interface display method provided in the embodiment of this application, in addition to displaying a task completion condition of a current level, the level completion interface further includes a task progress bar for displaying a stage goal completion progress. By using the task progress bar, the user can directly view a goal in a current phase and a corresponding goal achievement reward without interface switch, thereby improving viewing efficiency.

In addition, the task progress bar can dynamically update a progress value according to the task completion condition, and display a goal in a next stage and a corresponding goal reaching reward after the progress value reaches the goal in the current stage, so that the user can focus attention on the current stage and the next stage, thereby helping improve challenge enthusiasm of the user, and avoiding affecting the challenge enthusiasm of the user due to interference to obtaining the effective information by the user because of displaying excessive stage goals.

Solutions provided in the aspects described herein are applicable to terminals such as smartphones, tablet computers, ebook readers, and personal computers. In some embodiments, information displayed in the level completion interface may be determined by a terminal itself, or may be obtained after the terminal interacts with a background server. That is, in the solution provided in the embodiment of this application, the terminal may display the level completion interface without the help of the background server, or may display the level completion interface by interacting with the background server.

The level completion interface may be an application interface of an application program in the terminal, or a web page interface of a web page accessed by the terminal. Conditions of triggering display of the level completion interface are different for different types of application programs or web pages. In some embodiments, the level completion interface may be an interface displayed after a game level is passed, or may be an interface displayed after tasks such as a sharing task, a promotion task, a like task, and a check-in task are completed in various applications. This application does not limit a specific manner of triggering the display of the level completion interface and specific content displayed in the level completion interface. For ease of description, in the following embodiments, an example in which the level completion interface is an interface displayed after a level is passed in a game application is used for description, but this is not limited thereto.

Referring to FIG. 2, which shows a flowchart of a level completion interface display method provided in an exemplary embodiment of this application. The method includes:
operation 201: Display a task completion condition of a current level and a task progress bar in a level completion interface, where the task progress bar includes an i^{th} stage goal and an i^{th} goal achievement reward corresponding to the i^{th} stage goal.

In some embodiments, the level completion interface is triggered to be displayed after the current level is passed. In this embodiment, an example in which the current level is a game level in a game application is used for description.

In one possible implementation, at least one level task is set for each level, and the task completion condition displayed in the level completion interface is a completion condition of each level task.

In some embodiments, task quantities of level tasks set in different levels may be the same or may be different. For example, three level tasks are set for each level, or quantities of level tasks set for levels 1 to 5 are respectively 3, 3, 2, 3, and 4.

In some embodiments, level task types set in different levels may be the same or may be different. For example, three level tasks are set for each level, and the level task types are level passing time, level passing score, and number of revivals. Alternatively, a level task type of a level task set for each level includes at least one of the level passing time, the level passing score, the number of revivals, blood volume of a character, a prop use condition, or an enemy defeat condition.

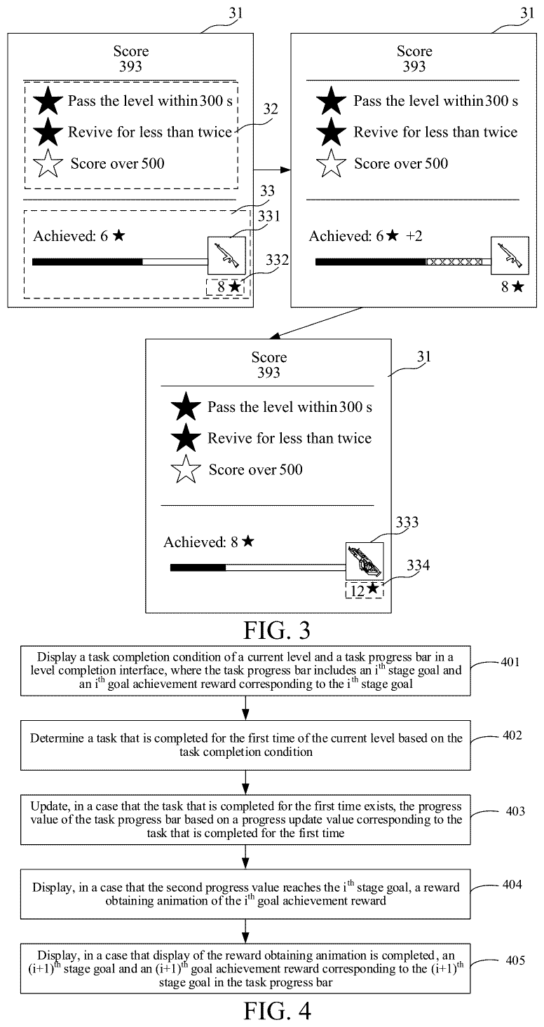

Schematically, as shown in FIG. 3, a level completion interface 31 displays a task completion condition 32. In the task completion condition 32, whether each level task is completed is indicated by using a star. A black star indicates that a corresponding level task has been completed, and a white star indicates that a corresponding level task has not been completed.

According to one or more aspects, in addition to the task completion condition, the level completion interface further includes a task progress bar. The task progress bar is configured to indicate a completion condition of a stage goal, and the completion condition of the stage goal is related to task completion conditions of different levels.

The task progress bar corresponds to a first progress value.

Schematically, when a current level is ended and a level completion interface is displayed, in addition to displaying the task completion condition, the first progress value is also displayed on the task progress bar. The first progress value is a progress value determined based on a task completion condition within previous levels, and can reflect a task completion condition of a game played by a player within the previous levels. In addition, the first progress value can further be dynamically updated according to the task completion condition of the current level.

For example: the previous levels passed by the player include a level 1 and a level 2, the current level is a level 3, and the task completion condition corresponding to the level 3 that is displayed in the level completion interface is: a task a and a task b have been completed, and a task c has not been completed. The level completion interface further displays a first progress value 6, configured for comprehensively displaying the task completion conditions of the game played by the player at the level 1 and the level 2. For example, a contribution value of the task completion condition corresponding to the level 1 to the progress bar is 4, a contribution value of the task completion condition corresponding to the level 2 to the progress bar is 2, and the first progress value is a sum of the contribution value 4 and the contribution value 2. The first progress value may further be dynamically updated according to the task completion condition corresponding to the level 3. For example: based on that the player completes the task a and the task b in the level 3, the contribution value is 2. Therefore, the first progress value may be dynamically updated by using the contribution value 2. The contribution value herein may be a numerical value, a weight value of the task, or the like, which is not limited herein.

In some embodiments, the stage goal is related to accumulative task completion quantities of different levels, different stage goals correspond to different accumulative task completion quantities, and accumulative task completion quantities corresponding to different stage goals are ascending.

In some embodiments, different stage goals correspond to different goal achievement rewards. The goal achievement rewards may include virtual gold coins, virtual props, experience, and the like, which is not limited in the embodiment of this application.

To enable the user to focus on a stage goal of a current stage, the task progress bar includes the i^{th} stage goal and the i^{th} goal achievement reward corresponding to the i^{th} stage goal, where the i^{th} stage goal is the latest-stage goal that has not been currently achieved.

Schematically, as shown in FIG. 3, a task progress bar 33 is displayed below the task completion condition 32. A tail of the task progress bar 33 includes a first-stage goal 332 and a corresponding first goal achievement reward 331. The first-stage goal is that the accumulative task completion quantity reaches 8, that is, 8 stars are accumulated.

Operation 203: Display a second progress value.

The second progress value is a progress value obtained by updating the first progress value based on the task completion condition.

Because a level task may be completed when a current level is passed, to enable the user to learn the achieving progress of the stage goal more intuitively and in real time, the terminal dynamically updates the first progress value of the task progress bar based on the task completion condition. The first progress value of the task progress bar is related to the accumulative task completion quantity.

In some embodiments, when the task completion conditions are displayed one by one, the terminal updates the first progress value of the progress bar when all the task completion conditions are displayed.

In some embodiments, the terminal needs to determine, based on the task completion condition, whether the first progress value needs to be updated, and updates the first progress value when determining that the first progress value needs to be updated. When the progress value does not need to be updated, the terminal maintains the current first progress value of the task progress bar.

In one possible implementation, the terminal quantifies the task completion condition as a progress update value, and updates the first progress value of the task progress bar based on the progress update value on the basis of a current first progress value, so as to obtain the second progress value. That is: the second progress value is the updated first progress value. The second progress value is greater than the first progress value.

In some embodiments, when the task completion condition is quantified as the progress update value, a task completion quantity at the current level is used as the progress update value.

For example: the task completion condition indicates that the task completion quantity at the current level is 2, and 2 is used as the progress update value to update the first progress value.

In some embodiments, when the task completion condition is quantified as the progress update value, at least one task completed at the current level and a task weight respectively corresponding to the at least one task are determined; and the progress update value is determined based on the task weight respectively corresponding to the at least one task. The task weight is a weight value preset for a task.

For example: the task completion condition indicates that one task a and three tasks b are completed at the current level, a task weight corresponding to the task a is 0.5, and a task weight corresponding to the task b is 0.8; the progress update value obtained by combining the task a and the task b is 2.9-0.5*1+0.8*3.

The foregoing example of obtaining the progress update value based on quantification of the task completion condition is merely an exemplary description, and is not limited herein.

Schematically, as shown in FIG. 3, when it is determined, based on the task completion condition 32, that two stars need to be added, the terminal updates the first progress value of the task progress bar 33 to obtain the second progress value.

In some embodiments, the terminal determines whether the second progress value achieves the i^{th} stage goal. If the i^{th} stage goal is achieved, operation 205 is executed, or if the i^{th} stage goal is not achieved, the i^{th} stage goal and the i^{th} goal achievement reward are continuously displayed in the task progress bar.

Operation 205: Display, in a case that the second progress value achieves the i^{th} stage goal, an (i+1)^{th} stage goal and an (i+1)^{th} goal achievement reward corresponding to the (i+1)^{th} stage goal in the task progress bar.

When the i^{th} phase goal is achieved, to enable the user to learn a next-stage goal and a corresponding goal achievement reward in time, the terminal displays the (i+1)^{th} phase goal and the corresponding (i+1)^{th} goal achievement reward in the task progress bar.

In some embodiments, in a case that the i^{th} stage goal is achieved, the task progress bar displays both the i^{th} stage goal and the (i+1)^{th} stage goal, or the task progress bar displays only the (i+1)^{th} stage goal.

Schematically, as shown in FIG. 3, based on the current progress value (six stars), after it is determined, based on the task completion condition 32, that two stars need to be added, the progress value of the task progress bar 33 achieves the first-stage goal 332, and the terminal displays a second-stage goal 334 and a corresponding second goal achievement reward 333 at the tail of the task progress bar 33. The second-stage goal is that the accumulative task completion quantity reaches 12, that is, 12 stars are accumulated.

In conclusion, in the embodiment of this application, in addition to displaying the task completion condition of the current level, the task progress bar is further displayed on the level completion interface, and the user can view the goal in the current stage and the corresponding goal achievement reward by using the task progress bar. In addition, the first progress value corresponding to the task progress bar supports dynamic update according to the task completion condition to obtain the second progress value. After the second progress value reaches a current-stage goal, the task progress bar can display a next-stage goal and a corresponding goal achievement reward, so that the user can quickly learn stage goal information of the current stage and a next stage through the level completion interface, and interface switching does not need to be performed between the level completion interface and a stage goal display interface, thereby improving information viewing efficiency. In addition, the level completion interface focuses display of the stage goals at the current stage and the next stage, so as to avoid interference caused to the user to obtain effective information due to display of excessive stage goals.

To enable the user to learn the obtained goal achievement rewards in time, and to improve the user's level passing enthusiasm, when the stage goal is achieved, the terminal may further display a reward obtaining animation.

Referring to FIG. 4, which shows a flowchart of a level completion interface display method provided in another exemplary embodiment of this application. The method includes:

operation 401: Display a task completion condition of a current level and a task progress bar in a level completion interface, where the task progress bar includes an i^{th} stage goal and an i^{th} goal achievement reward corresponding to the i^{th} stage goal.

The task progress bar corresponds to a first progress value.

A specific implementation of this operation may refer to the above operation embodiment. Details are not described in this embodiment.

With regard to display positions of the i^{th} stage goal and the i^{th} goal achievement reward, in one possible implementation, the i^{th} stage goal and the i^{th} goal achievement reward are located at a tail of the task progress bar.

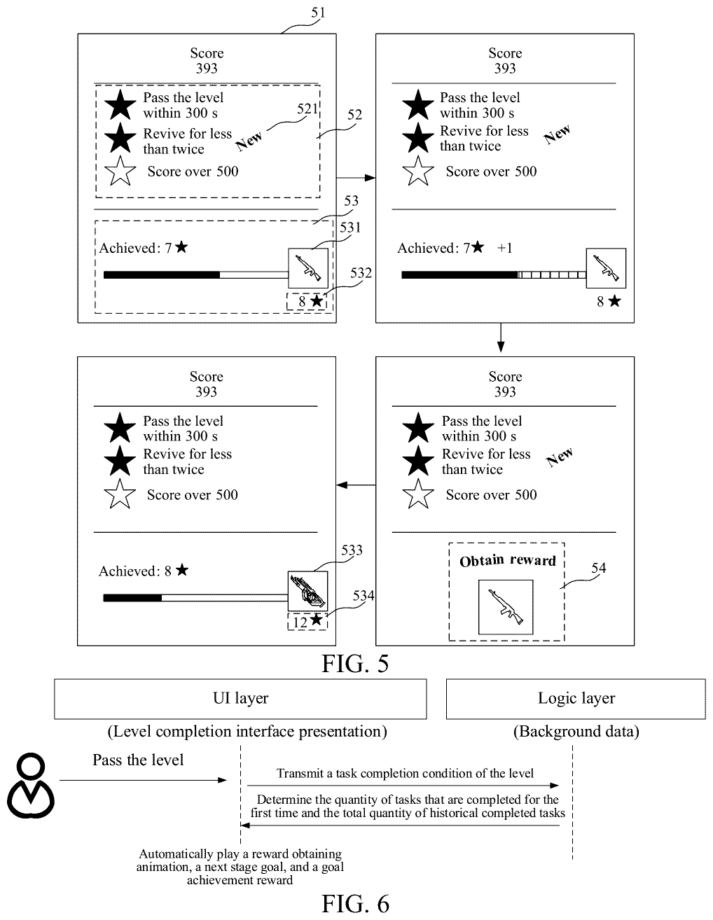

As shown in FIG. 5, a level completion interface 51 displays a task completion condition 52 and a task progress bar 53. A first stage goal 532 and a first goal achievement reward 531 are located at a tail of the task progress bar 53.

Operation 402: Determine a task that is completed for the first time of the current level based on the task completion condition.

The task that is completed for the first time is configured for representing a task that is completed within the current level for the first time.

In one possible scenario, the user may repeatedly pass through the same level for multiple times, so as to complete different level tasks. In a case that the current level is not passed for the first time, the task completion condition of the current level may include level tasks that are repeatedly completed. To avoid repeatedly updating a progress value based on the level tasks that are repeatedly completed, in the embodiment of this application, the terminal needs to determine the task that is completed for the first time of the current level, and update the progress value based on the task that is completed for the first time.

Regarding a manner of determining the task that is completed for the first time, in one possible implementation, the terminal determines historical completed tasks of the current level, and determines the task that is completed for the first time of the current level based on the historical completed tasks and a completed task indicated by the task completion condition. The task that is completed for the first time belongs to the completed task and does not belong to the historical completed tasks.

For example, when the completed tasks indicated by the task completion condition include tasks 1 and 2, and the historical completed tasks of the current level include the task 1, the terminal determines that the task that is completed for the first time is the task 2.

In the foregoing process, the content of the task that is completed for the first time is comprehensively determined according to the historical completed tasks and the completed task, the completed task is determined according to the task completion condition at the current level, and the historical completed tasks are screened from the completed task by using the historical completed task as a defining condition, and the task that is completed for the first time is determined, thereby improving quantifiability of determining the task that is completed for the first time, so that determining of the task that is completed for the first time is more accurate, and further facilitating a more accurate process of updating the progress value according to the task that is completed for the first time.

In some embodiments, as shown in FIG. 6, a game application is taken as an example, the game application includes a User Interface (UI) layer and a logical layer. The UI layer is responsible for level completion interface presentation, and the logical layer is responsible for background data processing. When the current level is passed, the UI layer transmits the task completion condition of the current level to the logical layer, and the logical layer determines the quantity of tasks that are completed for the first time based on historical completed tasks of the current level and completed tasks indicated by the task completion condition, and feeds back the quantity of the tasks that are completed for the first time and a total quantity of the historical completed tasks to the UI layer. The UI layer updates the progress value of the task progress bar based on the quantity of the tasks that are completed for the first time, and when a stage goal is achieved, automatically plays a reward obtaining animation, as well as a next-stage goal and a goal achievement reward.

In some other embodiments, to avoid cheating on a terminal side, the terminal may transmit a level identifier of the current level and the task completion condition to a server. The server obtains the historical completed tasks of the current level based on the level identifier, determines the tasks that are completed for the first time based on the historical completed tasks and the completed task indicated by the task completion condition, and feeds back the quantity of the tasks that are completed for the first time and the total quantity of the historical completed tasks to the terminal for display by the terminal.

In a case that the tasks that are completed for the first time exist, to ensure accuracy of subsequent progress update, the terminal updates the historical completed tasks of the current level based on the tasks that are completed for the first time. Alternatively, the server updates the historical completed tasks of the current level based on the tasks that are completed for the first time.

The content herein describes the content of updating the tasks that are completed for the first time to the historical completed tasks. After the tasks that are completed for the first time are determined, the tasks that are completed for the first time are summarized as the historical completed tasks, to avoid occurrence of a case in which the player incorrectly determines the tasks that are completed for the first time when the player subsequently performs a game level, so as to avoid a problem that the same task is repeatedly determined as the task that is completed for the first time, thereby improving accuracy of determining the task that is completed for the first time subsequently, and enhancing progress value update efficiency.

In some embodiments, in a case that it is determined that the task that is completed for the first time exists, the terminal displays a first completion prompt around a task entry corresponding to the task that is completed for the first time.

The task entry is an area corresponding to the task. For example: a plurality of tasks respectively correspond to one task entry, and information related to the tasks is represented by using the task entry; alternatively, information displayed around the task entry is used as related information of the tasks.

Schematically, as shown in FIG. 5, the terminal determines that a level task “Revive for less than twice” is the task that is completed for the first time, and displays a first completion mark 521 beside the level task.

The first completion prompt is displayed around the task entry corresponding to the task that is completed for the first time, so that the player can learn a first completion condition of the task more clearly, thereby encouraging the player to continuously complete the task, and enhancing interesting of the game and also improving human-machine interaction efficiency in a game process.

When the task that is completed for the first time exists, the terminal performs operation 403; and when no task that is completed for the first time exists, the terminal maintains the current progress value of the task progress bar.

Operation 403: Update, in a case that the task that is completed for the first time exists, the progress value of the task progress bar based on a progress update value corresponding to the task that is completed for the first time.

In a case that the task that is completed for the first time exists, the terminal quantifies the progress value of the task that is completed for the first time to obtain the progress update value, so as to update the task progress bar based on the progress update value. In one possible implementation, the terminal determines the progress update value based on the quantity of the tasks that are completed for the first time.

Schematically, as shown in FIG. 5, since one task that is completed for the first time exists, the terminal determines that the progress update value is 1, and displays the progress update value around the task progress bar 53.

In some embodiments, the content that quantifies the progress value of the task that is completed for the first time may refer to the foregoing content that quantifies the task completion condition into the progress update value. That is: the task completion condition corresponding to the task that is completed for the first time is quantified as the progress update value, which is not limited herein.

In one possible implementation, the first completion prompt and the progress update value may be displayed in a linked manner, so that the user learns an update basis of the progress value more clearly.

Operation 402 to operation 403 describe the content of updating the first progress value according to the task that is completed for the first time. A case in which the player may perform repeated games on a plurality of levels to repeatedly complete the same task is fully considered, the task that is completed for the first time is used as a condition for updating the first progress value, and the progress update value corresponding to the task that is completed for the first time is determined, so as to update the first progress value in a goaled manner according to the progress update value, thereby improving the accuracy in a process of updating the progress value, so as to determine a completion condition of a stage goal based on a more accurate second progress value, and fully encourage the player to complete uncompleted tasks within the levels while ensuring the game accuracy, thereby improving the game interest.

Operation 404: Display, in a case that the second progress value reaches the i^{th} stage goal, a reward obtaining animation of the i^{th} goal achievement reward.

Regarding a display manner of the reward obtaining animation, in one possible implementation, the task progress bar is reset in a case that the second progress value reaches the i^{th} stage goal, and the terminal displays the reward obtaining animation and a reset task progress bar operation by operation. That is, in a case that the second progress value reaches the i^{th} stage goal, the terminal stops displaying the task progress bar, and displays the reward obtaining animation of the i^{th} goal achievement reward.

Schematically, as shown in FIG. 5, when the second progress value reaches 8, the terminal stops displaying the task progress bar 53 on the level completion interface 51, and displays a reward obtaining animation 54 of the first goal achievement reward 531.

The foregoing content introduces that when the reward obtaining animation is displayed, display of the task progress bar is first stopped, and then the reward obtaining animation is displayed, so as to avoid interference of the task progress bar to the display of the reward obtaining animation, so that an animation display effect is more apparent.

In one possible implementation, the terminal stores reward obtaining animations corresponding to different stage goals. After determining the second progress value based on the current progress value and the progress update value, the terminal determines a stage goal that is achieved by the second progress value, and plays a reward obtaining animation corresponding to the stage goal.

Operation 405: Display, in a case that display of the reward obtaining animation is completed, an (i+1)^{th} stage goal and an (i+1)^{th} goal achievement reward corresponding to the (i+1)^{th} stage goal in the task progress bar.

In one possible implementation, when the display of the reward obtaining animation is completed, the terminal resets the task progress bar, and displays the (i+1)^{th} stage goal and the (i+1)^{th} goal achievement reward in a reset task progress bar. The i^{th} stage goal and the i^{th} goal achievement reward are no longer displayed in the reset task progress bar, and the (i+1)^{th} stage goal and the (i+1)^{th} goal achievement reward are located at a tail of the reset task progress bar.

Regarding a resetting manner of the task progress bar, in some embodiments, the terminal determines an initial filling position of the task progress bar based on a current progress value and the (i+1)^{th} stage goal, so as to display the reset task progress bar based on the initial filling position.

Schematically, as shown in FIG. 5, after the reward obtaining animation 54 is played, the terminal displays the reset task progress bar 53 in the level completion interface 51. The second stage goal 534 and the second goal achievement reward 533 are located at the tail of the task progress bar 53.

The foregoing content describes that when the i^{th} stage goal and the i^{th} goal achievement reward are located at the tail of the task progress bar, based on a case that the second progress value reaches the i^{th} stage goal, the (i+1)^{th} stage goal and the (i+1)^{th} goal achievement reward may be displayed at the tail of the reset task progress bar, that is, the display content at the tail of the progress bar is updated, so that the tail of the progress bar can always display a stage goal that the player needs to achieve next, thereby emphasizing importance of the stage goal, so that the player pursues the stage goal to a greater extent, and improving a game excitation effect.

In some embodiments, in a case that the i^{th} stage goal is achieved, the terminal determines whether the (i+1)^{th} stage goal exists, that is, determines whether a current stage goal is the last stage goal. If the (i+1)^{th} stage goal exists, the terminal displays the (i+1)^{th} stage goal and the (i+1)^{th} goal achievement reward in the reset task progress bar; and if no (i+1)^{th} stage goal exists, the terminal displays a task progress bar in a progress completion state after displaying the reward obtaining animation.

The progress completion state is configured for representing that the i^{th} stage goal is the last stage goal.

In some embodiments, the task progress bar in the progress completion state may include a progress completion identifier, and the task progress bar is fully filled.

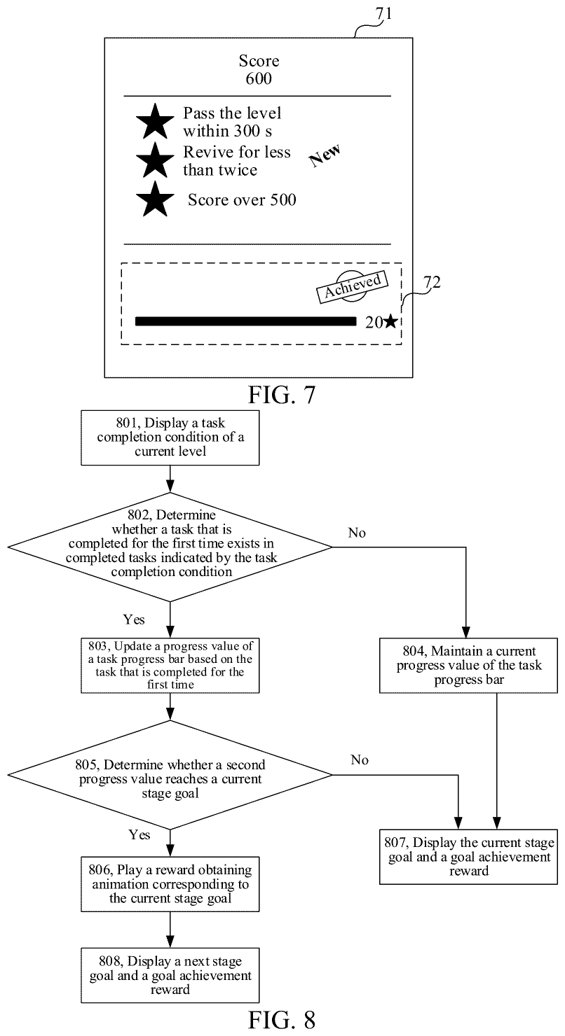

Schematically, as shown in FIG. 7, a level completion interface 71 displays a task progress bar 72 in a progress completion state.

Whether the i^{th} stage goal is the last extreme goal is determined more accurately according to whether there is auxiliary in the (i+1)^{th} stage goal, thereby strengthening relationships between a current stage goal and a plurality of stage goals, so as to display, in a case that the (i+1)^{th} stage goal exists, the (i+1)^{th} stage goal and the (i+1)^{th} goal achievement reward in the reset task progress bar, and display the task progress bar in a progress completion state in a case that no (i+1)^{th} stage goal exists, so as to more intuitively display completion conditions of the stage goals to the player by virtue of display conditions of different task progress bars, thereby improving the interest in a game process.

The foregoing operation 404 to operation 405 introduce the contents of display of the reward obtaining animation, the (i+1)^{th} stage goal, and the (i+1)^{th} goal achievement reward corresponding to the (i+1)^{th} stage goal. When the second progress value reaches the i^{th} stage goal, the reward obtaining animation indicating that the player obtains the i^{th} goal achievement reward is displayed to dynamically display that the player obtains the i^{th} goal achievement reward; and in addition, after the display of the reward obtaining animation is completed, the (i+1)^{th} stage goal and the (i+1)^{th} goal achievement reward corresponding to the (i+1)^{th} stage goal may further be displayed to encourage the player to continue playing a game level and execute a related task, to strive for obtaining the (i+1)^{th} goal achievement reward, thereby improving human-machine interaction efficiency.

In one schematic example, as shown in FIG. 8, a level completion process includes the following operations:
operation 801: Display a task completion condition of a current level.
Operation 802: Determine whether a task that is completed for the first time exists in completed tasks indicated by the task completion condition. If the task that is completed for the first time exists, execute operation 803; and if no task that is completed for the first time exists, execute operation 804.
Operation 803: Update a progress value of a task progress bar based on the task that is completed for the first time.
Operation 804: Maintain a current progress value of the task progress bar.
Operation 805: Determine whether a second progress value reaches a current stage goal. If the second progress value reaches the current stage goal, execute operation 806; and if the second progress value does not reach the current stage goal, execute operation 807.
Operation 806: Play a reward obtaining animation corresponding to the current stage goal.
Operation 807: Display the current stage goal and a goal achievement reward.
Operation 808: Display a next stage goal and a goal achievement reward.

In this embodiment, the terminal determines, based on historical completed tasks and the completed tasks indicated by the task completion condition, the task that is completed for the first time, and updates the progress value based on the task that is completed for the first time, so as to ensure accuracy of updating the progress value. In addition, the terminal displays the progress value update, the reward obtaining animation, and a reset task progress bar operation by operation, so that the user can focus on the current stage goal and the next stage goal, and learn a reward obtained after the stage goal is achieved in time.

In the foregoing embodiment, only an example in which the second progress value reaches a single-stage goal is used for description. In another possible scenario, when the second progress value reaches a plurality of stage goals, the terminal may sequentially display a reward obtaining animation of a goal achievement reward corresponding to each stage goal and reset the task progress bar. For example, when the second progress value reaches first and second stage goals, the level completion interface sequentially displays the task progress bar (including the first stage goal and a first goal achievement reward), updates the progress value of the progress bar, displays a reward play animation of the first goal achievement reward, displays a reset task progress bar (including the second stage goal and a second goal achievement reward), updates the progress value of the progress bar, displays a reward play animation of the second goal achievement reward, and displays a reset task progress bar (including a third stage goal and a third goal achievement reward). Details are not described herein again in this embodiment.

In addition to using the foregoing blocking display manner to display the reward obtaining animation and the reset task progress bar operation by operation, in another possible implementation, when the current stage goal is reached, the terminal may simultaneously display the current stage goal and the next stage goal in the task progress bar, and display the reward obtaining animation of the current stage goal in the task progress bar, so as to improve continuity of information display.

In some embodiments, an i^{th} stage goal and an i^{th} goal achievement reward are located at a first location of the task progress bar, and the first location is located in a middle of the task progress bar. In a case that the second progress value reaches the i^{th} stage goal, the terminal displays the reward obtaining animation of the i^{th} goal achievement reward at the first location of the task progress bar.

The reward obtaining animation of the i^{th} goal achievement reward is displayed at the first location corresponding to the i^{th} stage goal, which can prompt the player more significantly, to notify, by using the reward obtaining animation, the player that the i^{th} goal achievement reward is currently obtained by reaching the i^{th} stage goal, thereby enhancing an excitation effect of the player in the game, and facilitating the player to continue the game process by passing another level.

In a case that the display of the reward obtaining animation is completed, the terminal displays an (i+1)^{th} stage goal and an (i+1)^{th} goal achievement reward at a second location of the task progress bar, where the second location is located behind the first location.

When the second progress value does not reach the i^{th} stage goal, the task progress bar only displays the i^{th} stage goal and the i^{th} goal achievement reward, and does not display the (i+1)^{th} stage goal and the (i+1)^{th} goal achievement reward, so that the user focuses attention on the current stage goal.

In some embodiments, the first location and the second location may be fixed locations in the task progress bar. For example, the first location is located at ⅓ of the task progress bar, and the second location is located at ⅔ of the task progress bar.

In some embodiments, the first location may be a fixed location in the task progress bar, and a distance between the second location and the first location is related to a progress value difference between adjacent stage goals. Alternatively, the second location may be a fixed location in the task progress bar, and a distance between the first location and the second location is related to the progress value difference between the adjacent stage goals. For example, the first location is located at ⅓ of the task progress bar, and a larger progress value difference between the adjacent stage goals indicates a farther distance between the second location and the first location.

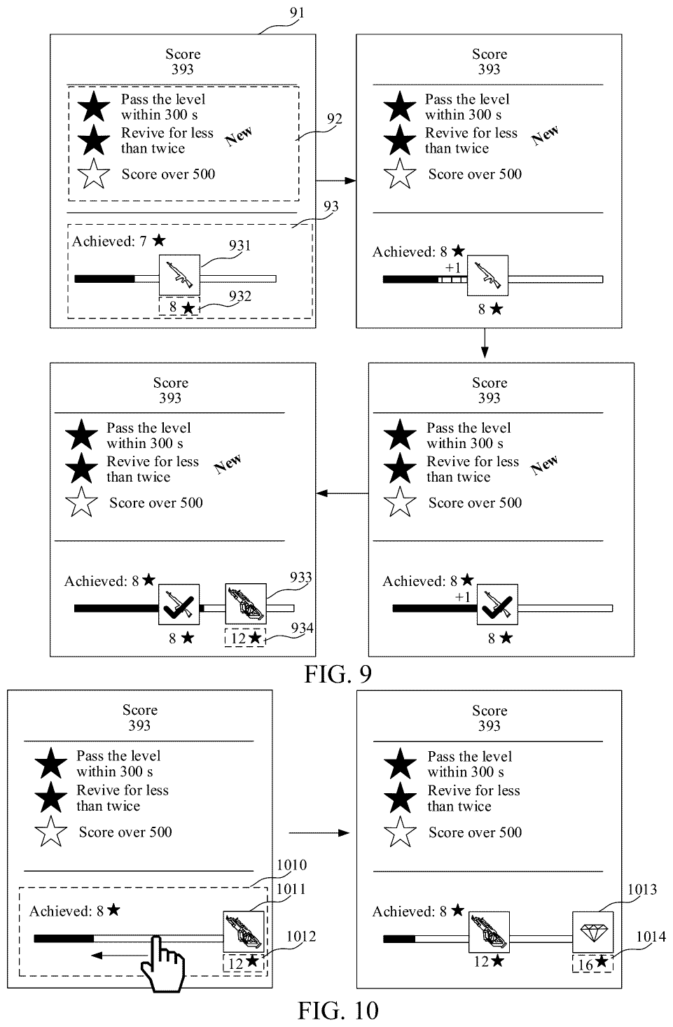

Schematically, as shown in FIG. 9, a task completion condition 92 and a task progress bar 93 are displayed in a level completion interface 91. A first stage goal 932 and a first goal achievement reward 931 are displayed in a first location of the task progress bar 93. When a progress value of the task progress bar 93 is updated based on the task completion condition 92, and a second progress value reaches the first stage goal 932, the terminal displays a reward obtaining animation at the first location of the task progress bar 93 (a hooking animation is displayed on a reward icon). After the display of the reward obtaining animation is completed, a second stage goal 934 and a second goal achievement reward 933 are displayed at a second position of the task progress bar 93.

The foregoing introduces the content that the stage goals and the goal achievement rewards are displayed at different locations according to achievements of the stage goals. If the i^{th} stage goal and the i^{th} goal achievement reward are located at the first location in the middle of the task progress bar, when the second progress value reaches the i^{th} stage goal, the (i+1)^{th} stage goal and the (i+1)^{th} goal achievement reward are displayed at the second location after the first location in the task progress bar, to strengthen a relationship between different stage goals by using a horizontal progress representation of the task progress bar, so as to encourage the player to continuously achieve the current stage goal, and strive for achieving a later stage goal, thereby improving the game interest and improving the human-machine interaction efficiency.

In the foregoing embodiment, only an example in which the second progress value reaches a single-stage goal is used for description. In another possible scenario, when the second progress value reaches a plurality of stage goals, the terminal may sequentially display a reward obtaining animation of a goal achievement reward corresponding to each stage goal and reset the task progress bar. For example, when the second progress value reaches the first and second stage goals, the task progress bar sequentially displays the first stage goal and the first goal achievement reward, updates the progress value, displays the reward play animation of the first goal achievement reward, displays the second stage goal and the second goal achievement reward, updates the progress value, displays the reward play animation of the second goal achievement reward, and displays a third phase goal and a third goal achievement reward. Details are not described herein again in this embodiment.

To make it convenient for the user to view another stage goal and the goal achievement reward, in one possible implementation, the task progress bar supports dragging for viewing. In response to a dragging operation on the task progress bar, an (i+j)^{th} stage goal and an (i+j)^{th} goal achievement reward corresponding to the (i+j)^{th} stage goal are displayed in the task progress bar, where j is an integer.

When j is a positive integer, the (i+j)^{th} stage goal is an unachieved stage goal after the current stage goal. When j is a negative integer, the (i+j)^{th} stage goal is an achieved stage goal before the current stage goal.

In some embodiments, when a dragging direction of the dragging operation is a first direction, the value of j is a positive integer; and when the dragging direction of the dragging operation is a second direction, the value of j is a negative integer.

In some embodiments, each time a dragging distance reaches a goal distance, the terminal updates the stage goal displayed in the task progress bar.

Schematically, as shown in FIG. 10, a second stage goal 1012 and a second goal achievement reward 1011 are displayed in a task progress bar 1010. When the user drags the task progress bar 1010 leftwards, a third phase goal 1014 and a third goal achievement reward 1013 are displayed in the task progress bar 1010.

The foregoing process introduces the content of displaying different phase goals and corresponding goal achievement excitations according to the dragging operation. In addition to displaying the i^{th} stage goal and the i^{th} goal achievement reward, the task progress bar further has a dragging function, and may display other stage goals and corresponding goal achievement rewards by means of the dragging operation, so that a plurality of stage goals are visualized, and the player can accurately grasp a game progress according to the dragging operation, the player can strive for a goal achievement excitation in a goaled manner, thereby improving a game excitation effect, greatly expanding interaction manners between the player and the terminal, and improving the human-machine interaction efficiency.

In one possible design, the task completion interface further includes a repeated challenge control. By triggering the control, the user may rechallenge the current level. To improve the challenge enthusiasm of the user, in one possible implementation, in a case that the second progress value does not reach the i^{th} stage goal and the current level has uncompleted tasks, the terminal highlights the repeated challenge control in the level completion interface, so as to prompt the user that the current level may be challenged again to increase the progress value, and to obtain the goal achievement reward.

The highlighting manner may include highlighting, magnification, animation, and the like, which is not limited in the embodiment of this application.

In some embodiments, in a case that the second progress value does not reach the i^{th} stage goal and the current level has no uncompleted tasks, the progress value cannot be increased when the user repeatedly challenges the current level, therefore, the repeated challenge control is displayed in a default manner.

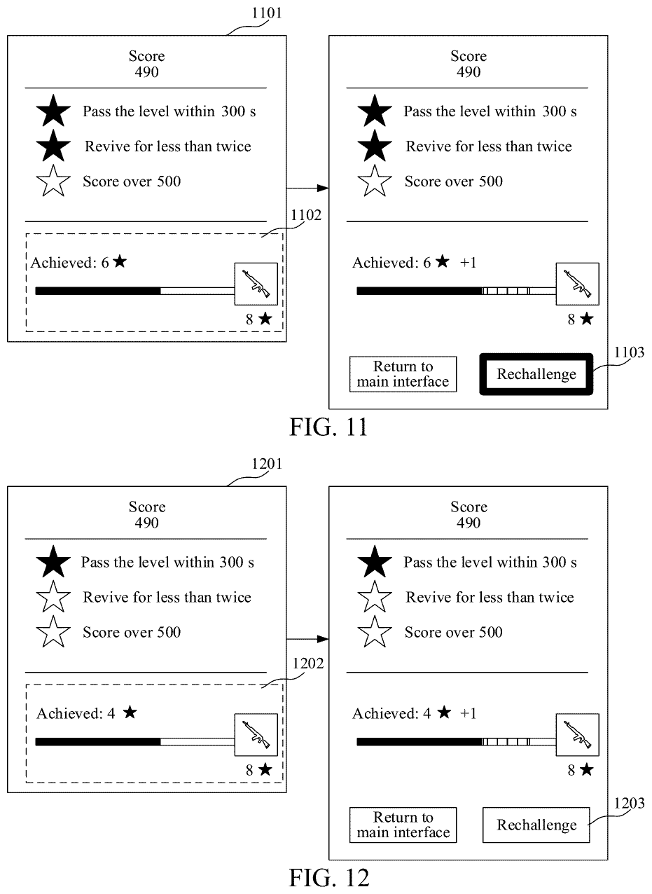

Schematically, as shown in FIG. 11, a second progress value in a task progress bar 1102 is 7. Because the current stage goal is not reached, and the current level has uncompleted level tasks, the terminal highlights (highlights) a rechallenge control 1103 in a level completion interface 1101.

In some embodiments, in a case that the second progress value does not reach the i^{th} stage goal and the current level has uncompleted tasks, the terminal determines a progress difference between the second progress value and the i^{th} stage goal and the quantity of uncompleted tasks in the current level.

If the quantity of uncompleted tasks is greater than or equal to the progress difference (the current stage goal can be achieved by completing all level tasks of the current level), the terminal highlights the repeated challenge control in the level completion interface.

If the quantity of uncompleted tasks is less than the progress difference (the current stage goal cannot be achieved by completing all level tasks of the current level), to avoid interference to the user due to frequent highlighting, the terminal displays the repeated challenge control in a default manner.

Schematically, as shown in FIG. 11, the second progress value in the task progress bar 1102 is 7, and the progress difference with the current stage goal is 1. Because the quantity of uncompleted level tasks of the current level is 1, the terminal highlights (highlights) the rechallenge control 1103 in the level completion interface 1101.

As shown in FIG. 12, a second progress value in a task progress bar 1202 is 5, and a progress difference with the current stage goal is 3. Because the quantity of uncompleted level tasks of the current level is 2, the terminal displays a rechallenge control 1203 in a level completion interface 1201 by default.

The foregoing content introduces the content that highlights the repeated challenge control according to the progress difference and the quantity of uncompleted tasks. After the progress value is updated from the first progress value to the second progress value based on the current task completion condition, if the second progress value does not reach the i^{th} stage goal, a progress difference may be determined to estimate the quantity of tasks needed by the player to reach the i^{th} stage goal, so that the repeated challenge control for the task that needs to be repeatedly challenged is highlighted by combining the quantity of uncompleted tasks and the progress difference, so that the player can execute the task in a goaled manner, thereby increasing the speed of reaching the i^{th} stage goal, and improving the human-machine interaction efficiency.

Further, in a case that the quantity of uncompleted tasks is greater than or equal to the progress difference, the terminal determines, according to an actual completion condition of the uncompleted tasks, a possibility of completing the uncompleted tasks during subsequent repeated challenge, and further determines, based on the possibility, a significance degree of the highlighting manner used by the repeated challenge control. When the possibility of completing the uncompleted tasks during repeated challenge is determined to be higher, the significance degree of the highlighting manner used by the repeated challenge control is higher.

In one possible implementation, when the quantity of uncompleted tasks is greater than or equal to the progress difference, the terminal determines a task indicator of the uncompleted tasks. The task indicator is task data that needs to be reached to complete the tasks. For example, the task indicator may be a level passing time indicator, a pass revival times indicator, a pass score indicator, and the like, which is not limited in this embodiment.

After the task indicator is determined, the terminal determines a display style of the repeated challenge control based on a difference between actual task data of the uncompleted tasks and the task indicator, so as to highlight the repeated challenge control based on the display style. The significance degree of the display style is in a negative correlation with the difference.

A smaller difference between the actual task data of the uncompleted tasks and the task indicator indicates a higher possibility of completing the uncompleted tasks when the user rechallenges the current level. Therefore, the terminal highlights the repeated challenge control in a more significant manner, so to improve a probability that the user rechallenges the current level, thereby improving the efficiency of achieving the current stage goal.

In some embodiments, when multiple uncompleted tasks exist, the terminal may integrate a total difference between actual task data of the multiple uncompleted tasks and the task indicators, so as to determine the display style of the repeated challenge control based on the total difference.

Schematically, as shown in FIG. 11, the second progress value in the task progress bar 1102 is 7, a progress difference with the current stage goal is 1, and the quantity of uncompleted level tasks of the current level is 1. Because a difference between actual task data “490” of the uncompleted level task and the task indicator “500” of the uncompleted level task is 10, display of the rechallenge control 1103 in the level completion interface 1101 is highlighted as a first brightness.

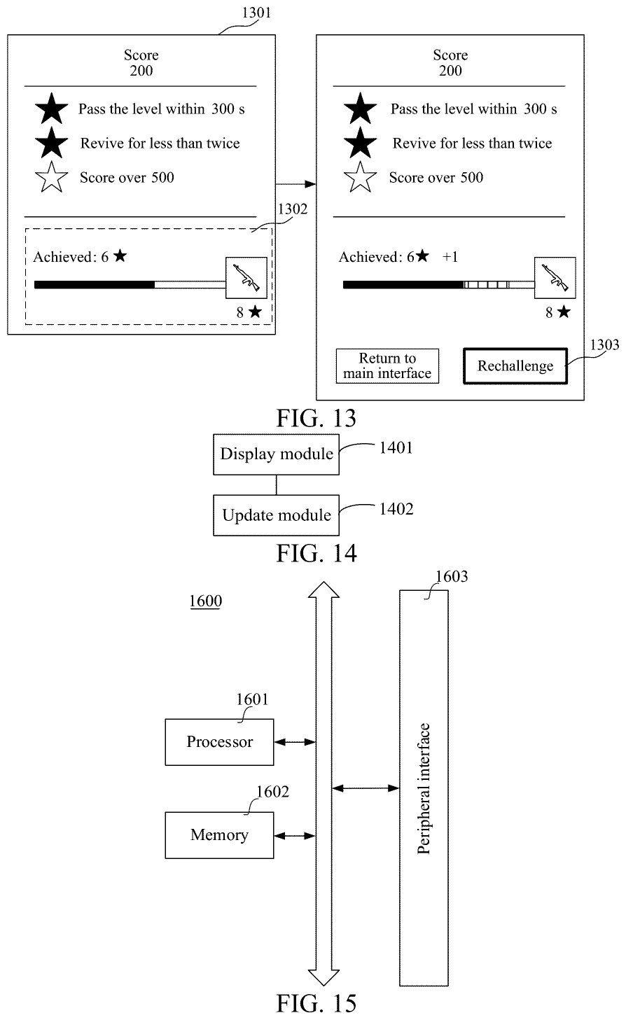

As shown in FIG. 13, a second progress value in a task progress bar 1302 is 7, a progress difference with a current stage goal is 1, and the quantity of uncompleted level tasks of the current level is 1. Because a difference between actual task data “200” of the uncompleted level task and the task indicator “500” of the uncompleted level task is 300, the display of a rechallenge control 1303 in a level completion interface 1301 is highlighted as a second brightness. The second brightness is lower than the first brightness.

In this embodiment, in a case that the second progress value does not reach the current stage goal, the terminal determines, with reference to a difference between an updated progress value and the current stage goal, the quantity of uncompleted tasks, and actual task data of the uncompleted tasks, whether the rechallenge control needs to be highlighted, and further determines a specific display style when highlighting needs to be performed, helping improve enthusiasm of repeated challenges.

In addition, when it is determined that the probability of achieving the stage goal is high during rechallenge, the probability of rechallenge can be improved by increasing the significance degree of the rechallenge control, and the player is encouraged to trigger the rechallenge control, thereby improving achieving efficiency of the stage goal.

Referring to FIG. 14, which shows a structural block diagram of a level completion interface display apparatus provided in an exemplary embodiment of this application. The apparatus includes:
a display module 1401, configured to display a task completion condition of a current level and a task progress bar in a level completion interface, the task progress bar including an i^{th} stage goal and an i^{th} goal achievement reward corresponding to the i^{th} stage goal, and the task progress bar corresponding to a first progress value; and
an update module 1402, configured to display a second progress value, where the second progress value is a progress value obtained by updating the first progress value based on the task completion condition.

The display module 1401 is further configured to display, in a case that the second progress value reaches the i^{th} stage goal, an (i+1)^{th} stage goal and an (i+1)^{th} goal achievement reward corresponding to the (i+1)^{th} stage goal in the task progress bar.

In some embodiments, the i^{th} stage goal and the i^{th} goal achievement reward are located at a tail of the task progress bar; and
the display module 1401 is configured to:
display the (i+1)^{th} stage goal and the (i+1)^{th} goal achievement reward in a reset task progress bar, where the (i+1)^{th} stage goal and the (i+1)^{th} goal achievement reward are located at a tail of the reset task progress bar.

In some embodiments, the display module 1401 is configured to:
display, in a case that the (i+1)^{th} stage goal exists, the (i+1)^{th} stage goal and the (i+1)^{th} goal achievement reward in the reset task progress bar; and
display, in a case that no (i+1)^{th} stage goal exists, the task progress bar in a progress completion state, where the progress completion state is configured for representing that the i^{th} stage goal is a last stage goal.

In some embodiments, the i^{th} stage goal and the i^{th} goal achievement reward are located at a first location of the task progress bar, and the first location is located in a middle of the task progress bar; and
the display module 1401 is configured to: display the (i+1)^{th} stage goal and the (i+1)^{th} goal achievement reward at a second location of the task progress bar, where the second location is located behind the first location.

In some embodiments, the display module 1401 is further configured to:
display, in a case that the second progress value reaches the i^{th} stage goal, a reward obtaining animation of the i^{th} goal achievement reward; and
display, in a case that the reward obtaining animation is displayed, the (i+1)^{th} stage goal and the (i+1)^{th} goal achievement reward corresponding to the (i+1)^{th} stage goal in the task progress bar.

In some embodiments, the task progress bar is reset in a case that the second progress value reaches the i^{th} stage goal; and
the display module 1401 is further configured to:
stop displaying, in a case that the second progress value reaches the i^{th} stage goal, the task progress bar, and display the reward obtaining animation of the i^{th} goal achievement reward.

In some embodiments, the i^{th} stage goal and the i^{th} goal achievement reward are located at a first location of the task progress bar, the (i+1)^{th} stage goal and the (i+1)^{th} goal achievement reward are located at a second location of the task progress bar, and the second location is located behind the first location; and
the display module 1401 is further configured to:
display, in a case that the second progress value reaches the i^{th} stage goal, a reward obtaining animation of the i^{th} goal achievement reward at the first position of the task progress bar.

In some embodiments, the update module 1402 is configured to:
determine a task that is completed for the first time of the current level based on the task completion condition, where the task that is completed for the first time is configured for representing a task that is completed within the current level for the first time; and
update, in a case that the task that is completed for the first time exists, the first progress value by using a progress update value corresponding to the task that is completed for the first time, and display the second progress value.

In some embodiments, the update module 1402 is configured to:
determine historical completed tasks of the current level; and
determine the task that is completed for the first time of the current level based on the historical completed tasks and a completed task indicated by the task completion condition, where the task that is completed for the first time belongs to the completed task and does not belong to the historical completed tasks; and
update, in a case that the task that is completed for the first time exists, the historical completed tasks of the current level based on the task that is completed for the first time.

In some embodiments, the display module 1401 is further configured to:
display a first completion prompt around a task entry corresponding to the task that is completed for the first time.

In some embodiments, the display module 1401 is further configured to:
display, in response to a dragging operation on the task progress bar, an (i+j)^{th} stage goal and an (i+j)^{th} goal achievement reward corresponding to the (i+j)^{th} stage goal in the task progress bar, where j is an integer.

In some embodiments, the display module 1401 is further configured to:
highlight, in a case that the second progress value does not reach the i^{th} stage goal and the current level has uncompleted tasks, a repeated challenge control on the level completion interface, where the repeated challenge control is configured to trigger to rechallenge the current level.

In some embodiments, the display module 1401 is further configured to:
determine, in a case that the second progress value does not reach the i^{th} stage goal and the current level has uncompleted tasks, a progress difference between the second progress value and the i^{th} stage goal and a quantity of uncompleted tasks of the current level; and
highlight, in a case that the quantity of uncompleted tasks is greater than or equal to the progress difference, the repeated challenge control on the level completion interface.

In some embodiments, the display module 1401 is further configured to:
determine, in a case that the quantity of uncompleted tasks is greater than or equal to the progress difference, a task indicator of the uncompleted tasks, where the task indicator is task data that needs to be reached to complete the tasks; and
determine a display style of the repeated challenge control based on a difference between actual task data of the uncompleted tasks and the task indicator, where a significance degree of the display style is in a negative correlation with the difference; and
highlight the repeated challenge control based on the display style.

In conclusion, in the embodiment of this application, in addition to displaying the task completion condition of the current level, the task progress bar is further displayed on the level completion interface, and the user can view the goal in the current stage and the corresponding goal achievement reward by using the task progress bar. In addition, the first progress value corresponding to the task progress bar supports dynamic update according to the task completion condition to obtain the second progress value. After the second progress value reaches a current-stage goal, the task progress bar can display a next-stage goal and a corresponding goal achievement reward, so that the user can quickly learn stage goal information of the current stage and a next stage through the level completion interface, and interface switching does not need to be performed between the level completion interface and a stage goal display interface, thereby improving information viewing efficiency. In addition, the level completion interface focuses display of the stage goals at the current stage and the next stage, so as to avoid interference caused to the user to obtain effective information due to display of excessive stage goals.

The apparatus provided in the foregoing embodiment is illustrated only with an example of division of the foregoing function modules. In practical applications, the foregoing functions may be allocated to and completed by different function modules according to requirements. That is, the internal structure of the apparatus is divided into different function modules to complete all or some of the functions described above. In addition, the apparatus and method embodiments provided in the foregoing embodiments belong to the same conception. For an implementation process, reference may be made to the method embodiments, and details are not described herein again.

Referring to FIG. 15, which shows a structural block diagram of a terminal 1600 provided in an exemplary embodiment of this application. The terminal 1600 may be a portable mobile terminal, for example: a smartphone, a tablet computer, a moving picture experts group audio layer III (MP3) player, and a moving picture experts group audio layer VI (MP4) player. The terminal 1600 may be further referred to as other names such as user equipment and a portable terminal.

The terminal 1600 generally includes: a processor 1601 and a memory 1602.

The memory 1602 may include one or more computer-readable storage media. The computer-readable storage medium may be tangible and non-transitory.

In some embodiments, the terminal 1600 may alternatively include: a peripheral device interface 1603 and at least one peripheral device.

In the embodiment of this application, the peripheral device includes an optical sensor. The optical sensor is configured to acquire ambient light intensity. In one embodiment, the processor 1601 may control a display brightness of a touch display screen according to the ambient light intensity acquired by the optical sensor. When the ambient light intensity is relatively high, the display brightness of the touch display screen is increased; and when the ambient light intensity is relatively low, the display brightness of the touch display interface is decreased.

A person skilled in the art may understand that the structure shown in FIG. 15 constitutes no limitation on the terminal 1600, and the terminal may include more or fewer components than those shown in the figure, or some components may be combined, or a different component deployment may be used.

An embodiment of this application further provides a computer-readable storage medium, having at least one instruction stored therein, where the at least one instruction is loaded and executed by a processor to implement the level completion interface display method in a virtual relationship developing application described in the foregoing embodiments.

An embodiment of this application provides a computer program product, and the computer program product includes computer instructions. The computer instructions are stored in a computer-readable storage medium. A processor of the computer device reads the computer instructions from the computer readable storage medium, and the processor executes the computer instructions, so that the computer device executes the level completion interface display method described in the foregoing embodiments.

A person of ordinary skill in the art may understand that all or some of the operations of the foregoing embodiments may be implemented by hardware, or may be implemented by a program instructing relevant hardware. The program may be stored in a computer-readable storage medium. The above-mentioned storage medium may be a read-only memory, a magnetic disk, an optical disc, or the like.

The foregoing descriptions are merely illustrative aspects described herein, but are not intended to limit this application. Any modification, equivalent replacement, or improvement made within the spirit and principle of this application shall fall within the protection scope of this application.

What is claimed is:

1. A method comprising:
displaying a task completion condition of a current level and a task progress bar in a level completion interface, the task progress bar comprising an i^{th} stage goal and an i^{th} goal achievement reward corresponding to the i^{th} stage goal, and the task progress bar corresponding to a first progress value;
displaying a second progress value, the second progress value being a progress value obtained by updating the first progress value based on the task completion condition; and
displaying, in a case that the second progress value reaches the i^{th} stage goal, an (i+1)^{th} stage goal and an (i+1)^{th} goal achievement reward corresponding to the (i+1)^{th} stage goal in the task progress bar.

2. The method according to claim 1, wherein the i^{th} stage goal and the i^{th} goal achievement reward are located at a tail of the task progress bar; and
the displaying an (i+1)^{th} stage goal and an (i+1)^{th} goal achievement reward corresponding to the (i+1)^{th} stage goal in the task progress bar comprises:
displaying the (i+1)^{th} stage goal and the (i+1)^{th} goal achievement reward in a reset task progress bar, wherein the (i+1)^{th} stage goal and the (i+1)^{th} goal achievement reward are located at a tail of the reset task progress bar.

3. The method according to claim 2, wherein the displaying the (i+1)^{th} stage goal and the (i+1)^{th} goal achievement reward in a reset task progress bar comprises:
displaying, in a case that the (i+1)^{th} stage goal exists, the (i+1)^{th} stage goal and the (i+1)^{th} goal achievement reward in the reset task progress bar; and
the method further comprises:
displaying, in a case that no (i+1)^{th} stage goal exists, the task progress bar in a progress completion state, the progress completion state being configured for representing that the i^{th} stage goal is a last stage goal.

4. The method according to claim 1, wherein the i^{th} stage goal and the i^{th} goal achievement reward are located at a first location of the task progress bar, and the first location is located in a middle of the task progress bar; and
the displaying an (i+1)^{th} stage goal and an (i+1)^{th} goal achievement reward corresponding to the (i+1)^{th} stage goal in the task progress bar comprises:
displaying the (i+1)^{th} stage goal and the (i+1)^{th} goal achievement reward at a second location of the task progress bar, the second location being located behind the first location.

5. The method according to claim 1, wherein prior to the displaying an (i+1)^{th} stage goal and an (i+1)^{th} goal achievement reward corresponding to the (i+1)^{th} stage goal in the task progress bar, the method further comprises:
displaying, in a case that the second progress value reaches the i^{th} stage goal, a reward obtaining animation of the i^{th} goal achievement reward; and
the displaying an (i+1)^{th} stage goal and an (i+1)^{th} goal achievement reward corresponding to the (i+1)^{th} stage goal in the task progress bar comprises:
displaying, in a case that the reward obtaining animation is displayed, the (i+1)^{th} stage goal and the (i+1)^{th} goal achievement reward corresponding to the (i+1)^{th} stage goal in the task progress bar.

6. The method according to claim 5, wherein the task progress bar is reset in a case that the second progress value reaches the i^{th} stage goal; and
the displaying, in a case that the second progress value reaches the i^{th} stage goal, a reward obtaining animation of the i^{th} goal achievement reward comprises:
stopping displaying, in a case that the second progress value reaches the i^{th} stage goal, the task progress bar, and displaying the reward obtaining animation of the i^{th} goal achievement reward.

7. The method according to claim 5, wherein the i^{th} stage goal and the i^{th} goal achievement reward are located at a first location of the task progress bar, the (i+1)^{th} stage goal and the (i+1)^{th} goal achievement reward are located at a second location of the task progress bar, the second location being located behind the first location; and
the displaying, in a case that the second progress value reaches the i^{th} stage goal, a reward obtaining animation of the i^{th} goal achievement reward comprises:
displaying, in a case that the second progress value reaches the i^{th} stage goal, a reward obtaining animation of the i^{th} goal achievement reward at the first position of the task progress bar.

8. The method according to claim 1, wherein the displaying a second progress value comprises:
determining a task that is completed for the first time of the current level based on the task completion condition, the task that is completed for the first time being configured for representing a task that is completed within the current level for the first time; and
updating, in a case that the task that is completed for the first time exists, the first progress value by using a progress update value corresponding to the task that is completed for the first time, and displaying the second progress value.

9. The method according to claim 8, wherein the determining a task that is completed for the first time of the current level based on the task completion condition comprises:
determining historical completed tasks of the current level; and
determining the task that is completed for the first time of the current level based on the historical completed tasks and a completed task indicated by the task completion condition, wherein the task that is completed for the first time belongs to the completed task and does not belong to the historical completed tasks; and
the method further comprises:
updating, in a case that the task that is completed for the first time exists, the historical completed tasks of the current level based on the task that is completed for the first time.

10. The method according to claim 8, wherein the method further comprises:
displaying a first completion prompt around a task entry corresponding to the task that is completed for the first time.

11. The method according to claim 1, further comprising:
displaying, in response to a dragging operation on the task progress bar, an (i+j)^{th} stage goal and an (i+j)^{th} goal achievement reward corresponding to the (i+j)^{th} stage goal in the task progress bar, j being an integer.

12. The method according to claim 1, further comprising:
highlighting, in a case that the second progress value does not reach the i^{th} stage goal and the current level has uncompleted tasks, a repeated challenge control on the level completion interface, the repeated challenge control being configured to trigger to rechallenge the current level.

13. The method according to claim 12, wherein the highlighting, in a case that the second progress value does not reach the i^{th} stage goal and the current level has uncompleted tasks, a repeated challenge control on the level completion interface comprises:
determining, in a case that the second progress value does not reach the i^{th} stage goal and the current level has uncompleted tasks, a progress difference between the second progress value and the i^{th} stage goal and a quantity of uncompleted tasks of the current level; and
highlighting, in a case that the quantity of uncompleted tasks is greater than or equal to the progress difference, the repeated challenge control on the level completion interface.

14. The method according to claim 13, wherein the highlighting, in a case that the quantity of uncompleted tasks is greater than or equal to the progress difference, the repeated challenge control on the level completion interface comprises:
determining, in a case that the quantity of uncompleted tasks is greater than or equal to the progress difference, a task indicator of the uncompleted tasks, the task indicator being task data that needs to be reached to complete the tasks; and
determining a display style of the repeated challenge control based on a difference between actual task data of the uncompleted tasks and the task indicator, a significance degree of the display style being in a negative correlation with the difference; and
highlighting the repeated challenge control based on the display style.

15. One or more computer readable media storing computer executable instructions that, when executed, configure a data processing system to perform a method comprising:
displaying a task completion condition of a current level and a task progress bar in a level completion interface, the task progress bar comprising an i^{th} stage goal and an i^{th} goal achievement reward corresponding to the i^{th} stage goal, and the task progress bar corresponding to a first progress value;
displaying a second progress value, the second progress value being a progress value obtained by updating the first progress value based on the task completion condition; and
displaying, in a case that the second progress value reaches the i^{th} stage goal, an (i+1)^{th} stage goal and an (i+1)^{th} goal achievement reward corresponding to the (i+1)^{th} stage goal in the task progress bar.

16. The computer readable media according to claim 15, wherein the i^{th} stage goal and the i^{th} goal achievement reward are located at a tail of the task progress bar; and
the displaying an (i+1)^{th} stage goal and an (i+1)^{th} goal achievement reward corresponding to the (i+1)^{th} stage goal in the task progress bar comprises:
displaying the (i+1)^{th} stage goal and the (i+1)^{th} goal achievement reward in a reset task progress bar, wherein the (i+1)^{th} stage goal and the (i+1)^{th} goal achievement reward are located at a tail of the reset task progress bar.

17. The computer readable media according to claim 6, wherein the displaying the (i+1)^{th} stage goal and the (i+1)^{th} goal achievement reward in a reset task progress bar comprises:
displaying, in a case that the (i+1)^{th} stage goal exists, the (i+1)^{th} stage goal and the (i+1)^{th} goal achievement reward in the reset task progress bar; and
the method further comprises:
displaying, in a case that no (i+1)^{th} stage goal exists, the task progress bar in a progress completion state, the progress completion state being configured for representing that the i^{th} stage goal is a last stage goal.

18. A system, comprising:
a processor; and
memory storing computer executable instructions that, when executed by the processor, configure the system to perform:
displaying a task completion condition of a current level and a task progress bar in a level completion interface, the task progress bar comprising an i^{th} stage goal and an i^{th} goal achievement reward corresponding to the i^{th} stage goal, and the task progress bar corresponding to a first progress value;
displaying a second progress value, the second progress value being a progress value obtained by updating the first progress value based on the task completion condition; and
displaying, in a case that the second progress value reaches the i^{th} stage goal, an (i+1)^{th} stage goal and an (i+1)^{th} goal achievement reward corresponding to the (i+1)^{th} stage goal in the task progress bar.

19. The system according to claim 18, wherein the i^{th} stage goal and the i^{th} goal achievement reward are located at a tail of the task progress bar; and
the displaying an (i+1)^{th} stage goal and an (i+1)^{th} goal achievement reward corresponding to the (i+1)^{th} stage goal in the task progress bar comprises:
displaying the (i+1)^{th} stage goal and the (i+1)^{th} goal achievement reward in a reset task progress bar, wherein the (i+1)^{th} stage goal and the (i+1)^{th} goal achievement reward are located at a tail of the reset task progress bar.

20. The system according to claim 19, wherein the displaying the (i+1)^{th} stage goal and the (i+1)^{th} goal achievement reward in a reset task progress bar comprises:
displaying, in a case that the (i+1)^{th} stage goal exists, the (i+1)^{th} stage goal and the (i+1)^{th} goal achievement reward in the reset task progress bar; and
the method further comprises:
displaying, in a case that no (i+1)^{th} stage goal exists, the task progress bar in a progress completion state, the progress completion state being configured for representing that the i^{th} stage goal is a last stage goal.
